(19) United States
(12) Patent Application Publication
(10) Pub. No.: US 2013/0297520 A1
(43) Pub. Date: Nov. 7, 2013

(54) Position Modeling Systems

(71) Applicant: MERCER (US) INC., New York, NY (US)

(72) Inventors: Darrell Cira, Radnot, PA (US); Mattias Jesper Klefback, Stockholm (SE); Brian Paul Fisher, Clarksville, IN (US); Heather M. Ryan, North Andover, MA (US); Mardi Weisblatt, West Orange, NJ (US)

(73) Assignee: Mercer (US) Inc., New York, NY (US)

(21) Appl. No.: 13/850,919

(22) Filed: Mar. 26, 2013

Related U.S. Application Data
(60) Provisional application No. 61/641,560, filed on May 2, 2012.

(51) Int. Cl. G06Q 10/10

(52) U.S. Cl. CPC G06Q 10/1053
USPC 705/321

(57) ABSTRACT

Position class modeling systems are presented. Modeling systems can include a position class modeling engine configured to model one or more positions within an organization as a position class as a function of one or more values of modeling factors. The modeling engine derives one or more elasticity of the modeling factors where the elasticity provides in indication of how a position class would change based on changes of the modeling factor values.

This application claims the benefit of priority to U.S. provisional application having Ser. No. 61/641,560 filed on May 2, 2012. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is human capital analysis technologies.

### BACKGROUND

Many corporations or other entities attempt to understand how positions within their organizations can affect their business. Each position can be considered a valuable asset to the company that should be well understood before the position is filled by a candidate. Some organizations attempt to represent the position's effect on the organization mathematically. However, such mathematical representations fail to fold in subjective factors that can vary from organization to organizations. Further, each type of factor (e.g., impact, communication, innovation, etc.) that is used to represent the position could affect the mathematical or algorithmic representation in different ways.

Some effort has been directed toward quantitatively representing a job seeker's desired position. For example, U.S. Pat. No. 8,001,057 to Hill titled “Quantitative Employment Search and Analysis System and Method”, filed May 15, 2008, describes deriving a quantitative value that represents a job seeker's suitability for existing positions. However, Hill fails to provide insight into how an organization can represent or assess an impact of a position in the first place, let along how subjective factors can affect a position's value.

Others have put forth effort toward quantifying business strategies. One example includes U.S. Pat. No. 6,859,785 to Case titled “Diagnostic Method and Apparatus for Business Growth Strategy”, filed Jan. 11, 2001. Case indicates that a corporate funding strategy could depend on market factors including a static elasticity of demand. Additional examples include U.S. Pat. No. 7,580,852 to Ouimet et al. titled “System and Method for Modeling Non-Stationary Time Series Using a Non-Parametric Demand Profile”, filed Feb. 23, 2005; and U.S. Pat. No. 8,032,406 to Ouimet titled “System and Method of Assortment, Space, and Price Optimization in Retail Store”, filed Jul. 28, 2006. Although useful for modeling business practices, these references fail to provide insight into how to model a position, especially where the modeling factors can affect the modeled position in different ways.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Interestingly, it has yet to be appreciated that factors used to model a position can have an elasticity associated with the position where the elasticity indicates a degree of effect the factors can have on a representation of the position. Thus, there is still a need for modeling system capable of modeling positions based on modeling factors where each modeling factor can have elasticity with respect to the model output.

### SUMMARY OF THE INVENTION

The inventive subject matter provides apparatus, systems and methods in which one can use a modeling engine to model one or more positions. One aspect of the inventive subject matter includes a modeling system comprising a user interface, a position class modeling engine, and a reporting engine. The user interface allows for input of one or more modeling factors representative of a position where a user, or other entity, can alter values associated with the modeling factors. The modeling engine derives one or more position classes associated with the position according to a position model as a function of the modeling factor values. Further, the modeling engine can derive an elasticity associated with each modeling factor where the elasticity indicates the relative effect of a modeling factor on the position class. The reporting engine can be configured to present the modeled position class and elasticity of the modeling factors. In some embodiments, the modeling system can also include a validation engine that can compare modeled elasticity to empirically derived elasticity to generate a validation of the position model.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a possible modeling system.

FIG. 2 is an example user interface presenting a modeled position and corresponding modeling factors.

FIG. 3 is another example user interface presenting side-by-side comparison of modeled position classes.

FIG. 4 is an example reporting interface that allows for generation of custom reports.

FIG. 5 is an example reporting interface that allows for filtering or sorting of data in a report.

FIG. 6 is an example reporting interfaces that provides for construction of custom reports with respect to one or more modeled position classes.

FIG. 7 illustrates selection of report generation criteria.

FIG. 8 also illustrates selection of report generation criteria.

FIG. 9 is a customized report showing a number of position classes based on the criteria selected in FIGS. 7 and 8.

### DETAILED DESCRIPTION

It should be noted that while the following description is drawn to a computer/server based modeling system, various alternative configurations are also deemed suitable and may employ various hardware-based computing devices including servers, interfaces, systems, databases, agents, peers, engines, controllers, or other types of computing devices operating individually or collectively. One should appreciate the computing devices comprise a hardware processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including generating one or more signals representative of a modeled position. The signals configure one or more devices to present information reflective of the modeled position.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, the terms “coupled to” and “coupled with” are also used to euphemistically mean “communicatively coupled with” in the context of a networking environment.

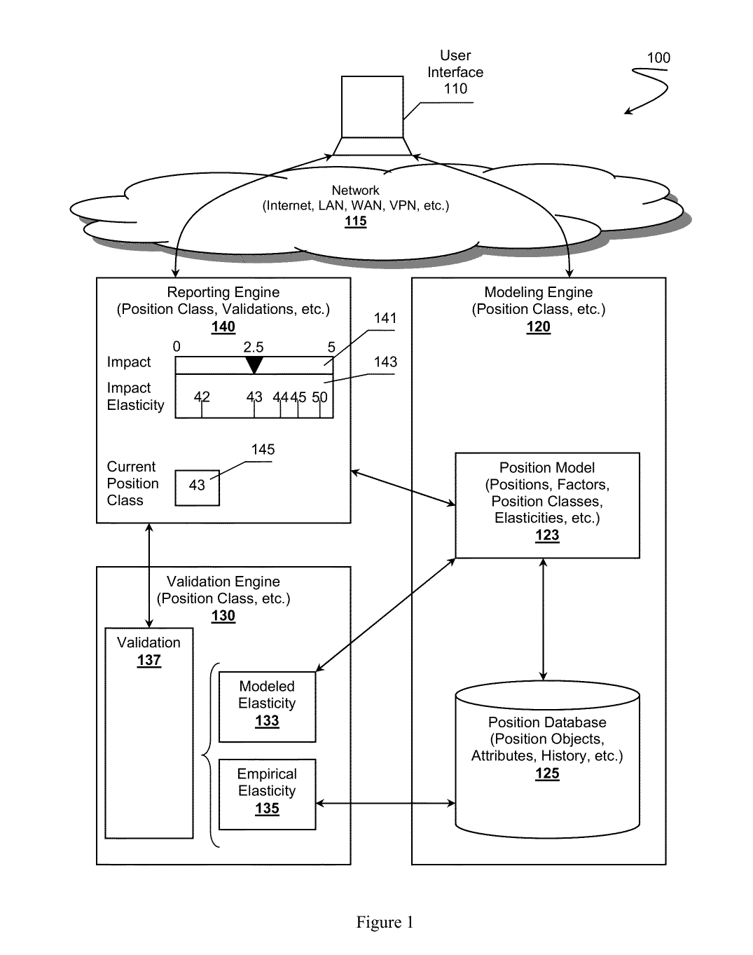

FIG. 1 presents position modeling ecosystem 100. Ecosystem 100 comprises user interface 110, modeling engine 120, reporting engine 140, and possibly validation engine 130. User interface 110 comprises a computing device configured to exchange data with at least modeling engine 120 and reporting engine 140. Example user interfaces 110 include a browser enabled computer, a tablet computer, a cell phone, or other suitably configured electronic device.

Modeling engine 120 can comprise one or more position class modeling engines capable of modeling a position (e.g., a job, roles, responsibilities, etc.) in an organization based on one or more modeling factors. Modeling engine 120 can include one or more servers (e.g., HTTP, SaaS, PaaS, IaaS, Cloud, etc.) offering their services to remote users over network 115. Example modeling factors include impact, communication, innovation, knowledge, risk, or other factors or simply view the factors differently. One should appreciate that such factors can be considered subjective factors where each organization might have different definitions for the factors. Further, modeling engine 120 can receive one or more modeling factor values that represent a quantification of each of the factors. The modeling factor values can be defined numerically, possibly on a defined scale (e.g., 1-5, 1-10, etc.). Once modeling engine 120 acquires the modeling factor values or other data, the modeling engine can apply one or more position models 123 (e.g., functions, algorithms, simulations, trends, analyses, etc.) to derive position class 145 associated with the position.

Position class 145 can comprise a single, normalized value. Such an approach is considered advantageous to allow distillation of many positions across multiple organizations and across jurisdictions (e.g., countries, political boundaries, geographies, demographics, etc.). By modeling a position to position class 145, one is able to compare a position's corresponding position class 145 against other positions throughout the world on equal footing, subject to application of subject factors. Although position class 145 comprises a single value, it is contemplated that position class 145 can also comprise multiple values where each value could reflect a different aspect or characteristic of the position. For example, position class 145 could include a normalized measure as discussed above, and have a second value that reflects a cultural relevance measure. The cultural relevance measure could be derived from compiled survey information, or from weightings applied to a position class based on jurisdiction. For example, an Indian firm might down-weight a position while a firm in the United States might up-weight a position. Such an approach is considered advantageous to organizations having growing populations of global workers.

In the example presented, modeling engine 120 derives at least one elasticity 143 associated with modeling factor value 141 (e.g., modeling factor value, degree of modeling factor dimension, etc.), illustrated as a subjective factor labeled “Impact”. Elasticity 143 can be considered a measure of how changes in modeling factor value 141 effect a resulting position class 145. In some embodiments, elasticity 143 can be expressed as a derivative or rate of change. For example, if modeling factor 141 is “impact” (I) as illustrated, elasticity 143 of impact with respect to position class 145 (PC) could be expressed as dPC/dI. One should appreciate that position class 145 can depend on many modeling factors 141. Therefore, elasticity 143 can also depend on one or more modeling factor 141 and could be represented by one or more partial derivatives with respect to more than one modeling factor 141. Still, further elasticity 143 can also include higher derivatives, possibly including those based on time: ∂²PC/ΔIΔt for example. Elasticity 145 can include a calculated elasticity, a modeled elasticity, or even an empirically measured elasticity. Thus, elasticity 143 can depend on one or more modeling factors 141.

Although the elasticity 145 is described with respect to derivatives, on should appreciate that the determination of elasticity 145 can be based on differences. For example, elasticity 143 could be calculated based on differences in position class 145 value at two points in time and with respect to differences in Impact. In such a scenario, elasticity can be represented as ∂²PC/ΔIΔt. Within the scope of the document, it should be understand the term “derivative” is considered to various forms of calculating a change of position class 145 with respect to at least one other factor 141. The derivative could include a continuous derivative, differences, or other representations of changes with respect to factors 141.

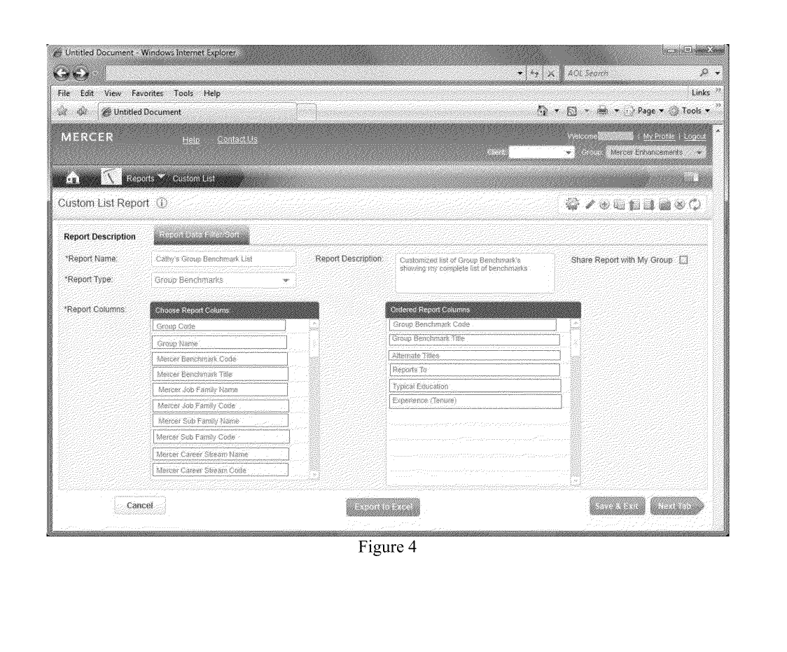

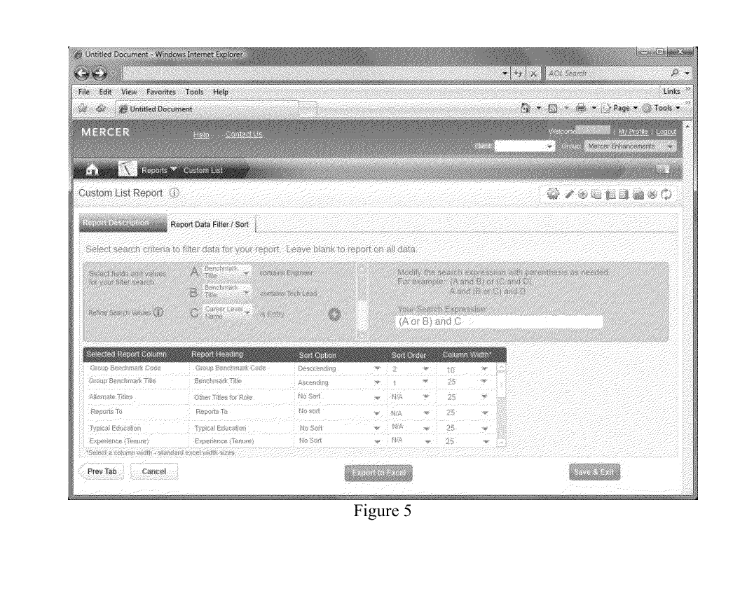

In the example shown, modeling engine 120 derives elasticity 143 with respect to modeling factor 143 representing “impact”. The position class modeling information is transmitted to reporting engine 140, which generates one or more reports as a function of the position class information, including elasticity 143. For example, reporting engine 140 can operate as a web service and present a web page to a user at user interface 110 (see also FIGS. 4 and 5).

Modeling factor 141 is illustrated as a slider, which can adjust the value of the modeling factor value according to a scale; 0 to 5 in this case. For illustrative purposes, elasticity 143 of the modeling factor is illustrated as a scale underneath the slider bar. Elasticity 143 illustrates how the corresponding position class 143 would be affected by changes in values of modeling factor 141. Note, in the example, the relationship between the value of modeling factor 141 and position class 145 is non-linear. Elasticity 143 is presented as non-linear just as one example of myriad possible relationships that could exist based on the corresponding position model 123.

Elasticity 143 is presented as a simple scale within FIG. 1. It is also contemplated that elasticity 143 can comprise more complex objects. In some embodiments, elasticity 143 can be presented along with a recommendation on changes to the modeling factor 141 that would shift the modeled position to a new position class 143. One should further appreciate that the elasticity 143, as shown, can include a range of values that would retain the position within a current position class 145.

In some embodiments, modeling engine 120 can also have access to one or more position databases 125 storing positions objects representative of modeled positions (e.g., current positions, historical positions, etc.), position classes, position surveys, position attributes, or other position related information. Each of the position objects can include position attributes describing the nature of the positions or corresponding position classes. Example attributes could include a corresponding set of position modeling factors. Such data is considered advantageous for use in further analytics. Statistical data collected from numerous organizations, possibly via surveys, can be used to determine validity of position model 123. Data from other various organizations can be sanitized to protect the organization's rights or privacy.

In the example show, modeling ecosystem 100 comprises validation 130 engine coupled with modeling engine 120 and the reporting engine 140. Validation engine 120 can acquire a modeled 133 or calculated elasticity from the modeling engine. Further, the validation engine can acquire or drive an empirical elasticity 135 based on the data available within position database 125. Validation engine 125 can use the statistical data from database 125 to measure empirical values of corresponding modeling factors of position class 143. Validation engine can then use the measured empirical values to derive one or more empirical elasticity 135. Through comparing empirical elasticity 135 to modeled elasticity 133, validation engine 130 can generate validation 137 of position model 123. If both elasticities affect position class 143 in a similar fashion, position model 123 would appear to be validated. If the elasticities affect position class 143 in different ways, position model 123 would appear to be invalid.

Position class validation 137 can include a measure of validity that can be expressed according to different schemes. Validity could include one or more of the following: a confidence level, a normalized value on a scale (e.g., 1 to 100), a percentage overlap, or other type of measure. Once validation 137 is formed, it is can be sent to the reporting engine for presentation. Beyond a measure of validity, validation 137 can also include one or more recommendations on alterations of the position model to better map to the empirical data.

Although ecosystem 100 is presented as different components distributed across network 115, one should appreciate that the roles or responsibilities of each component can be combined with each other as desired or disaggregated across multiple computing systems. For example, modeling engine 120 can incorporate reporting engine 140 and validation engine 130. All variations of the system are contemplated. Still further, modeling system 120 can also operate as a for-fee service. An example service that can be suitably adapted for use with the inventive subject matter includes the Mercer International Position Evaluation (IPE) service (see URL www.mercer.com/services/1351270). In exchange for a fee or other type of payment, the IPE service could present one or more elasticity 143 with respect to position classes 145. It is also contemplated that system 100 could be implemented as a standalone application; as a distributed system over a LAN, WAN, VPN, or other network 115; or as a web-based service as illustrated.

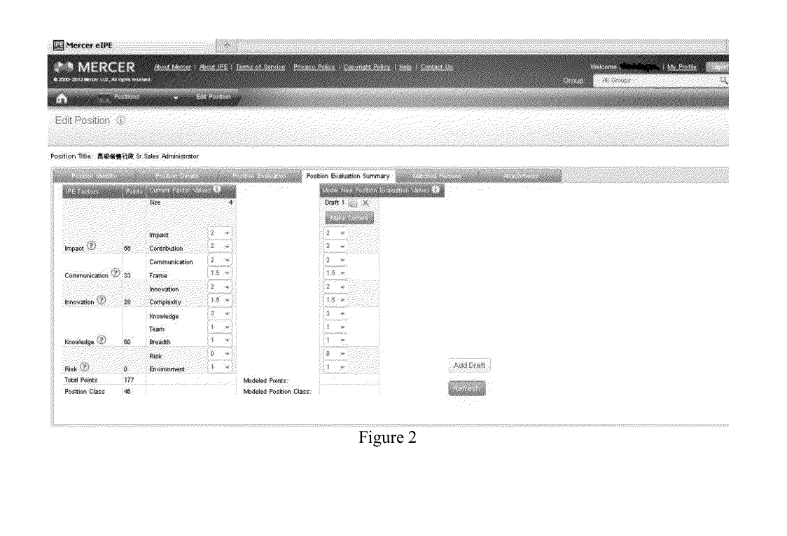

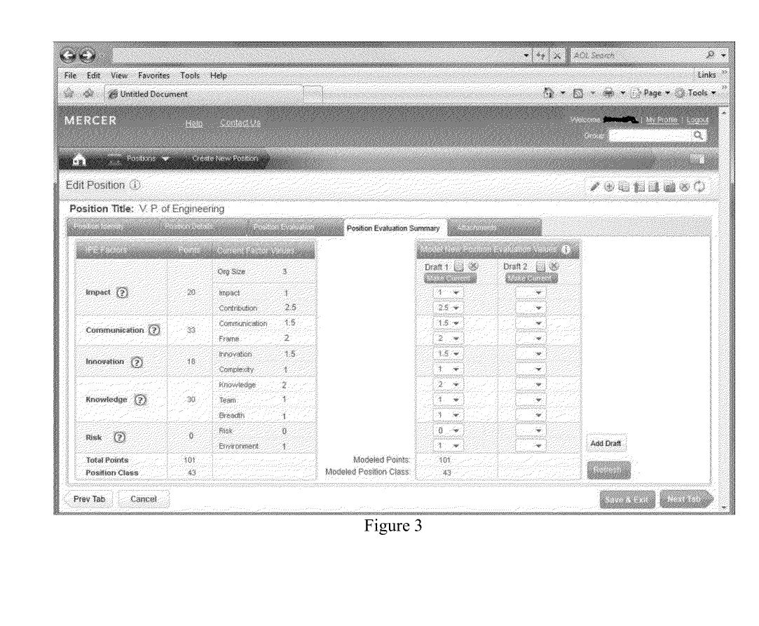

FIGS. 2 and 3 illustrate possible user interfaces where an organization's positions are modeled based on multiple IPE factors. In FIG. 2, a position is modeled to have a position class of 46. In FIG. 3, multiple models are generated for a single position where each “draft” of the position can have different position classes other than the original position class of 43 where each draft or position class can be presented in a side-by-side comparison. Each draft can include one or more modeling factor values allowing a user to model the position as different position classes rather than merely calculating a position class. In the example shown, a user is able to select a modeling factor value from drop down menus.

In additional preferred embodiments, the reporting engine can be further configured to generate one or more customized reports on the modeled position classes based on report generation criteria. A user, or other entity, can submit reporting criteria through a report interface: API, web page, etc. Example criteria that can be used to generate a report include a report type, a column selection, a row selection, a report field, a career stream, a group, a group benchmark, an organization, a user, a survey, a position code, elasticity representation, or other report properties.

FIGS. 4 and 5 provide examples of reporting interfaces that allow for generation of custom reports based on information generated during a position modeling session and based on information available within a position database.

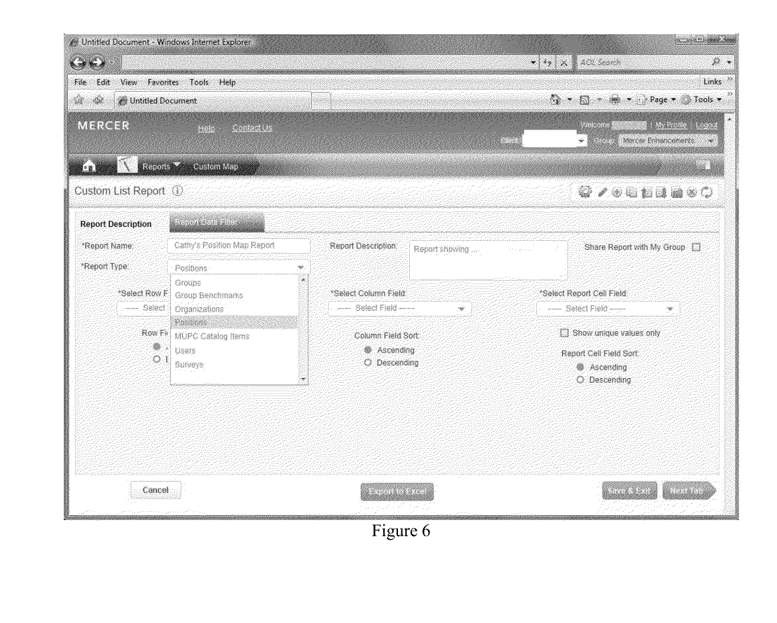

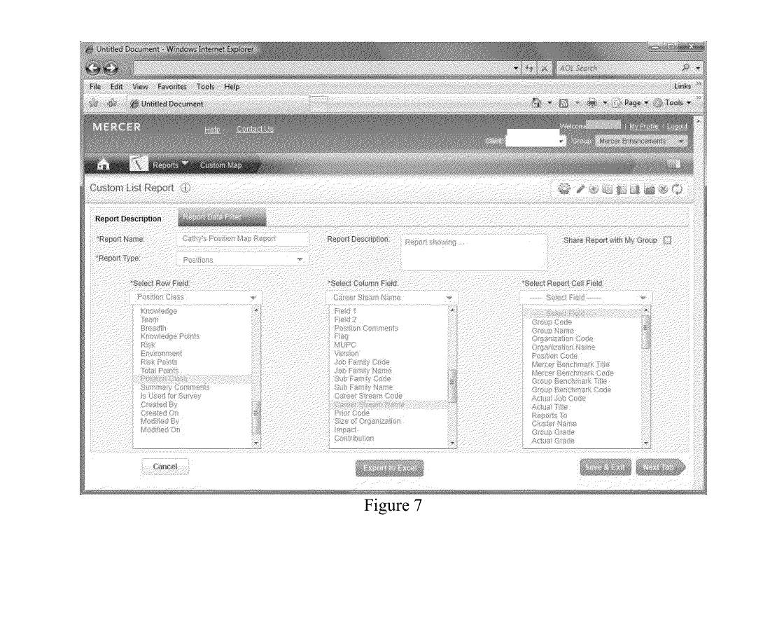

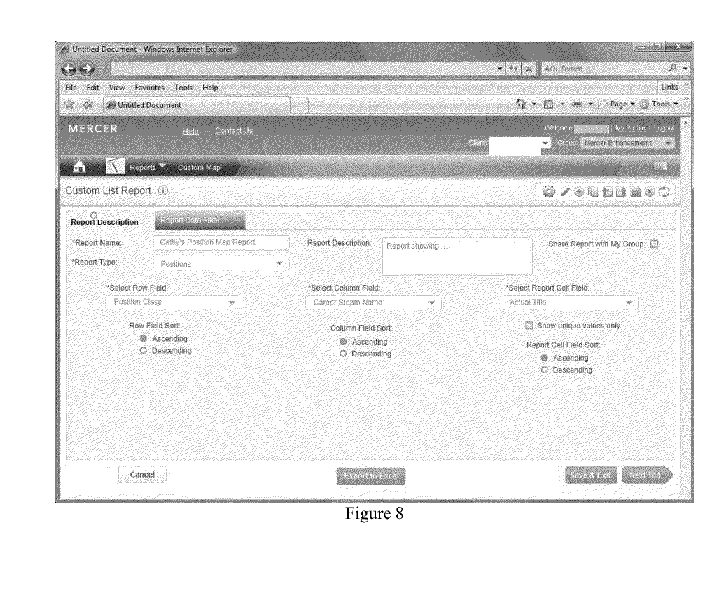

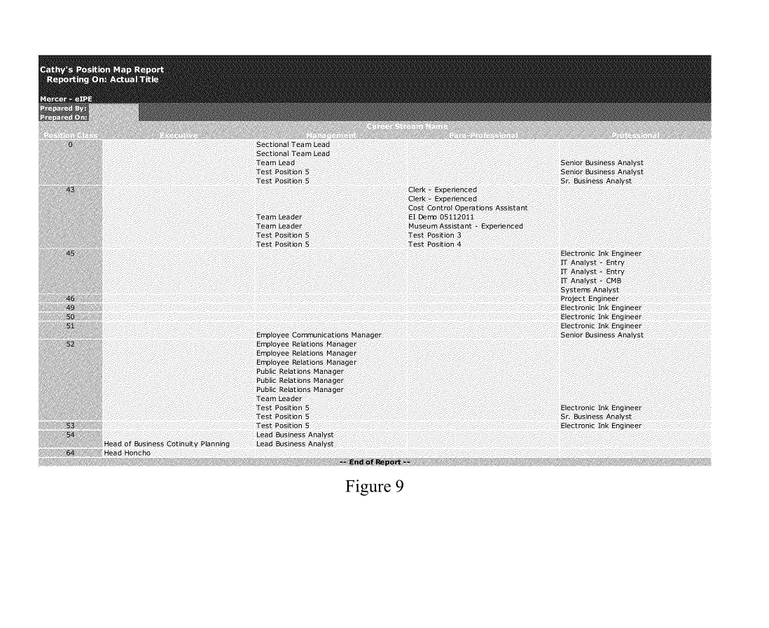

FIG. 6 illustrates selection of a report type via the reporting interface. Once the type of report is selected, positions in this example, the user can select other criteria for generating a report as illustrated in FIG. 7. FIG. 8 illustrates the criteria for a report of position class versus career stream where report is ready to be exported. FIG. 9 present a spreadsheet report constructed based on the steps illustrates in FIGS. 6-8.

The position class can be considered an expression of a relative value of the position under analysis as compared to other positions within the company, across other companies, or across other market data. One should appreciate that the comparison can be made with respect to internal data or external data. For example, FIG. 9 illustrates using a derived position class to compare a position of interest to other positions where all the position data has been aggregated based on internally generated survey data obtained from participating entities. In additional embodiments, external data can be incorporated into the comparison, possibly after suitable normalization with respect to the internal data. Thus, position classes allow an analyst to drill down further to see relationships between relative “job size” and remuneration packages across multiple positions, or types of positions (see Career Stream Names in FIG. 9; e.g., executive, management, para-professional, professional, technical, staff, etc.). Position classes also allow for a comparison of remuneration across job functions of similar size.

The examples provided within FIGS. 2-9 illustrate calculating position class based on five modeling factors defined as Impact, Communication, Innovation, Knowledge and Risk. Although these five factors are used in the examples, one should appreciate that any practical number of modeling factors can be employed. These modeling factors are used to determine a “job size” representing a quantification of the job. Further, each of the presented modeling factors are divided into one, two, three or more dimensions. Each dimension can have set degrees based on a scale of 1 to 5, and corresponding point values. Consider the example presented in FIG. 3 with respect to Impact. The Impact modeling factor includes a dimension with respect organization size. The organization size can be adjusted to a desired set to degree, “3” in the example shown in FIG. 3, where the degree of the organization size can be a single value representing the organizations size with respect to its revenue and weighting factors related to one or more of the position's value add to the organization (e.g., R&D, Engineering, Procurement, Production, Application, Marketing, Sales, Distribution, Service, etc.). Setting the degree of the modeling factor in turns generates a corresponding point value or contribution of points to the modeling factor.

Modeling factor dimension point values can be calculated through a number of different techniques. In some embodiment, the modeling engine uses the degree value as an index into a table to look up a number of points that corresponds to the degree. For example referring to the Communication modeling factor in FIG. 3, the modeling engine can consult a matrix where each cell of the matrix stores a point value and has a coordinate defined by the dimensions communication and frame. The modeling engine obtains the point value from the cell, possibly interpolating between neighboring cells when fractional degree values are used as shown. The interpolation can be linear or weighted depending on the nature of the marketing data that has given rise to the look up matrix. Such an approach is useful when the point values are derived from actual market survey data where the data does not necessarily follow a discernable mathematical trend. However, in other embodiments, the number of points can be derived as a function of the degree. For example, if a degree (d) value can range on a scale from 1 to 5, the corresponding points could be a non-linear function of degree (d), points=d² for example. The function could be determined by fitting one or more functions to empirical market data.

Regardless of how modeling factor points are calculated or otherwise derived, the modeling engine can aggregate the modeling factor points across all modeling factors into a total point value. Referring again to FIG. 3, each factor comprises a resulting point value (i.e., Impact=20 points, Communication=33 points, Innovation=18 points, Knowledge=30 points, and Risk=0 points). In the example shown, the total number of points is simply the sum of points and is equal to 101 points, although other functions of arriving at a total point value are contemplated. The total number of points can then be used to derive a position class.

One possible example method used to derive the position class, beyond those previously discussed, includes looking up the position class in a table by using the total number of points as an index. For example, a table can have position classes ranging from 0 to 87 (see FIG. 9 as an example of position classes from 0 to 64) where each position class can be defined by a range of total modeling factor points. Position class 40 might be defined as having a total point range from 26 to 50, while a position class 45 might be defined as having a total point range from 151 to 175. Although these ranges are of the same size, one should appreciate that each position class represent different sized ranges of total modeling factor points. Thus, the modeling engine need only find the position class where the total modeling factor points is greater than the position class's minimum range point value and the position class's maximum range point value (e.g., PositionClass_Min≦Total Points<PositionClass_Max). Other techniques can also be used to determine position class definitions, possibly including compiling statistical information from organizations based on survey data, or possibly including running Monte Carlo simulation that generates possible position definitions based on defined subjective factors.

In view that the position class can be derived as a function of a number of different factors, dimensions, weightings, data scales, or other parameters; the position class can change value in unexpected fashions, at least to an analyst, as the analyst adjusts the parameters due to non-linear behaviors resulting from the underlying market data. In the example shown in FIG. 3, the total points of 101 summed over the modeling factors results in a position class of 43. However, a small shift in a modeling factor or its dimensions could cause the position class to change. For example, if the Communication modeling factor's dimension of communication is shifted from 1.5 to 3 and the frame dimension is shifted from 2 to 3, could cause the contribution points from the Communication modeling factor to shift from 33 points to 60 points. The total number points could change from 101 to 128. This change could shift the position class from 43 to 44. Thus, an analyst can use the presented interface create different models of positions. The presented interface allows the analyst to create additional models, which could result in changes to the position class. Therefore, the analyst or other knowledge worker can be presented with an indication of the elasticity of the position class with respect to the modeling factors as discussed with respect to FIG. 1.

Although the subjective modeling factors described above can be based on market data, one should appreciate that each organization could represent the modeling factors differently or simply use completed distinct modeling factors beyond impact, communication, innovation, knowledge, or risk. For example, the modeling factors could include culture, creativity, or other factors. In such embodiments, the resulting position class can be used for multiple purposes. First, the organizations could use the position class as a pivot point to determine how the organizations quantify subjective factors differently. Second, the organizations could use the subjective factors to determine a distribution of position classes. In the first case, the modeling engine could generate a distribution of values for subject factors for a single value of position class. The distribution can then be used to determine cultural measures or other aspects related to how organizations use subjective factors with respect to their positions. In the second case the modeling engine can generate a distribution of position class values (e.g., discrete, continuous, curve fit, etc.) for one or more specific subjective factors.

An astute reader will appreciate the advantages of the disclosed subject matter. Analysts or other knowledge workers can leverage the disclosed modeling systems as a tool for analyzing organizational structures to support business strategies. For example, during a merger or acquisition, the analysts can determine costs associated with adjusting remuneration packages for acquire employees relative to their peers in the acquiring company as part of a job leveling exercise. Another example includes utilizing position class information to support temporary assignments, possibly where an employee is assigned into another country or other location.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A modeling system comprising:
a user interface configured to receive a set of modeling factor values representative of a position;
a position class modeling engine coupled with the user interface and configured to model the position according to a position model as function of the set of modeling factor values, and to derive a position class and at least one elasticity associated with the set of modeling factor values with respect to the position class; and
a reporting engine coupled with the modeling engine and configured to present the position class based on the elasticity.

2. The system of claim 1, wherein the reporting engine is further configured to present a plurality of position classes modeled based on different sets of modeling factor values.

3. The system of claim 2, wherein the reporting engine provides as side-by-side comparison of the plurality of position classes.

4. The system of claim 1, wherein the user interface is further configured to receive report generation criteria.

5. The system of claim 4, wherein the reporting engine is further configured to present the position class based on the report generation criteria.

6. The system of claim 4, wherein the report generation criteria includes at least on of the following: a report type, a column selection, a row selection, a report field, a career stream, a group, a group benchmark, an organization, a user, a survey, and a position code.

7. The system of claim 1, wherein the elasticity depends on a single modeling factor value in the set.

8. The system of claim 7, wherein the elasticity depends on at least two modeling factor values in the set.

9. The system of claim 1, wherein the elasticity comprises a recommendation on a change of at least one modeling factor value to shift the position to a new position class.

10. The system of claim 1, wherein the at least one elasticity comprises a range of values associated with at least one modeling factor value that retains the position within the position class.

11. The system of claim 1, further comprising a position database storing a plurality of position objects, each position object representative of the position and having position attributes including a set of position factors.

12. The system of claim 11, wherein the set of position factors comprise empirically measured factor values.

13. The system of claim 11, wherein the set of position factors directly map to the set of modeling factor values.

14. The system of claim 11, further comprising a validation engine coupled with the position database and the position modeling engine and configured to:
derive at least one empirical elasticity associated with at least one position factor in the set of position factors from position objects in the position database;
compare the at least one empirical elasticity to the at least one elasticity associated with the set of modeling factor values for corresponding positions to generate a validation of the position model; and
configure the reporting engine to present the validation of the position model.

15. The system of claim 14, wherein the position modeling engine comprises the validation engine.

16. The system of claim 1, herein the position class comprises a multi-valued position class.

17. The system of claim 1, wherein the position class comprises a single-valued position class.

18. The system of claim 1, wherein the set of modeling factor values comprise subjective values of the modeling factor values.
